(19) United States
(12) Patent Application Publication
(10) Pub. No.: US 2005/0203783 A1
(43) Pub. Date: Sep. 15, 2005

(54) Automated real-time event planning system and method

(76) Inventors: Michelle M. Allen, Seattle, WA (US); Robert E. Nielsen, Snoqualmie, WA (US); Joseph Petrucci, Mercer Island, WA (US); Paul K. Thackray, Seattle, WA (US); Terry J. Drayton, Medina, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 11/068,940

(22) Filed: Feb. 28, 2005

Related U.S. Application Data
(60) Provisional application No. 60/548,210, filed on Feb. 27, 2004.

(51) Int. Cl. G06F 17/60

(52) U.S. Cl. 705/5

(57) ABSTRACT

A real-time event planning system and method provides an automated interface that enables an event planner to create and publish events for which participants can immediately register. The system is designed to allow the event planner to configure all the characteristics of the event in real-time without requiring outside intervention, such as external program downloads or live assistance. An event can be made immediately available for prospective event participants to register and pay for the event.

### CROSS-REFERENCE TO RELATED APPLICATION

This application claims the benefit of the filing date of U.S. Provisional Patent Application No. 60/548,210, filed Feb. 27, 2004.

### FIELD OF THE INVENTION

The present invention relates generally to the field of event planning, and more particularly to systems and methods that permit the creation and publication of events or programs for which event participants can register.

### BACKGROUND OF THE INVENTION

The current state of the art of event planning requiring participant registration does not allow an event planner to easily create and publish an event on a computer network such that the event or program is immediately available for participants to register. Current event planning systems and methods require outside intervention, such as external program downloads or live assistance, to help event planners create and publish events on a computer network or registration. External program downloads, such as Java programs, can be difficult and cumbersome for users to install and operate, particularly for configuring complex database records. To allow for variables in each unique event or program, current systems require custom creation and configuration of database records on the host system, which is not easily accomplished by persons without technical training or assistance. What is needed is an automated system and method that facilitate real-time creation and publishing of events on a computer network without requiring outside intervention. The present invention addresses this need and other shortcomings in current event planning systems.

### SUMMARY OF THE INVENTION

Embodiments of the present invention provide new and useful methods and systems for creating and publishing events in real-time which are simpler in construction, more universally usable, and more versatile in operation than known systems of this kind. Embodiments of a real-time event planning system provided in accordance with the present invention have several advantages over the prior art, including without limitation:
1. a system that creates in real time a scheduled event for which end user participants are immediately able to register;
2. an interface that enables an event planner to create an event in real time that allows participants to immediately register for the event;
3. an interface that enables an event planner to easily add images or graphics in real time to an event created using the event planning system;
4. an interface that enables an event planner to easily add documents in real time to an event created using the event planning system;
5. an interface that enables an event planner to easily add event registration time constraints in real time to an event created using the event planning system;
6. an interface that enables an event planner to easily add in real time a maximum number of participants allowed to register for an event created using the event planning system;
7. an interface that enables an event planner to easily associate a vanity network address with the event in real time using the event planning system;
8. an interface that enables an event planner to easily monitor in real time the status of the event registrations; and
9. an interface that enables an event planner to easily add age restrictions in real time to the event.

Different embodiments of the invention may provide any one or combination of the advantages described above. Furthermore, other advantages of the invention that are apparent from the detailed description and illustrations provided herein are considered within the scope of the present invention.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIGS. 1A-1D provide exemplary screenshots of basic information input for setting up a reunion event according to one embodiment of the invention;

FIGS. 2A-2C provide exemplary screenshots of an event setup interface according to one embodiment of the invention;

FIG. 3 provides an exemplary screenshot of an event fees interface that can be used with the embodiment of the invention shown in FIGS. 2A-2C;

FIG. 4 provides an exemplary screenshot of an activation payment interface that can be used with the embodiment of the invention shown in FIGS. 2A-2C;

FIGS. 5A and 5B provide exemplary screenshots of an email invitation interface that can be used with the embodiment of the invention shown in FIGS. 2A-2C;

FIG. 6 provides an exemplary screenshot of a confirmation and receipt interface that can be used with the embodiment of the invention shown in FIGS. 2A-2C;

FIG. 7 provides an exemplary screenshot of a sample announcement and invitation that can be prepared using the embodiment of the invention shown in FIGS. 2A-2C;

FIG. 8 provides an exemplary screenshot of an event finder interface and registration link page that can be used to identify and access an event stored in a database using the embodiment of the invention shown in FIGS. 2A-2C;

FIG. 9 provides an exemplary screenshot of a “Your File” page that allows users to view their account and monitor the status of event registrations in real time;

FIG. 10 provides an exemplary screenshot of an event registration interface that enables participants to register for an event;

FIG. 11 provides an exemplary screenshot of an event registration fees summary that may be presented for confirmation by a registering participant;

FIG. 12 provides an exemplary screenshot of an event fees payment interface that participants may use to pay registration fees for an event; and

FIG. 13 is a system flow diagram of a real time event planning method that can be used in connection with the embodiment of the invention shown in FIGS. 1-8.

### DETAILED DESCRIPTION OF THE PREFERRED EMBODIMENT

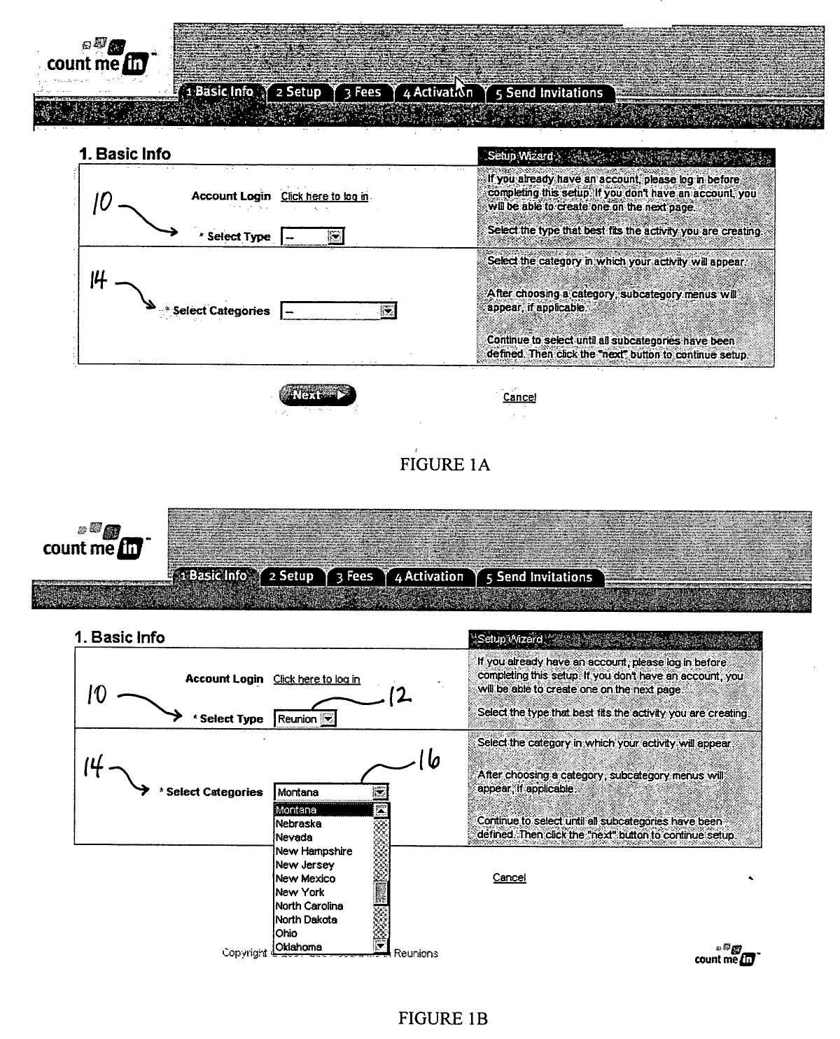

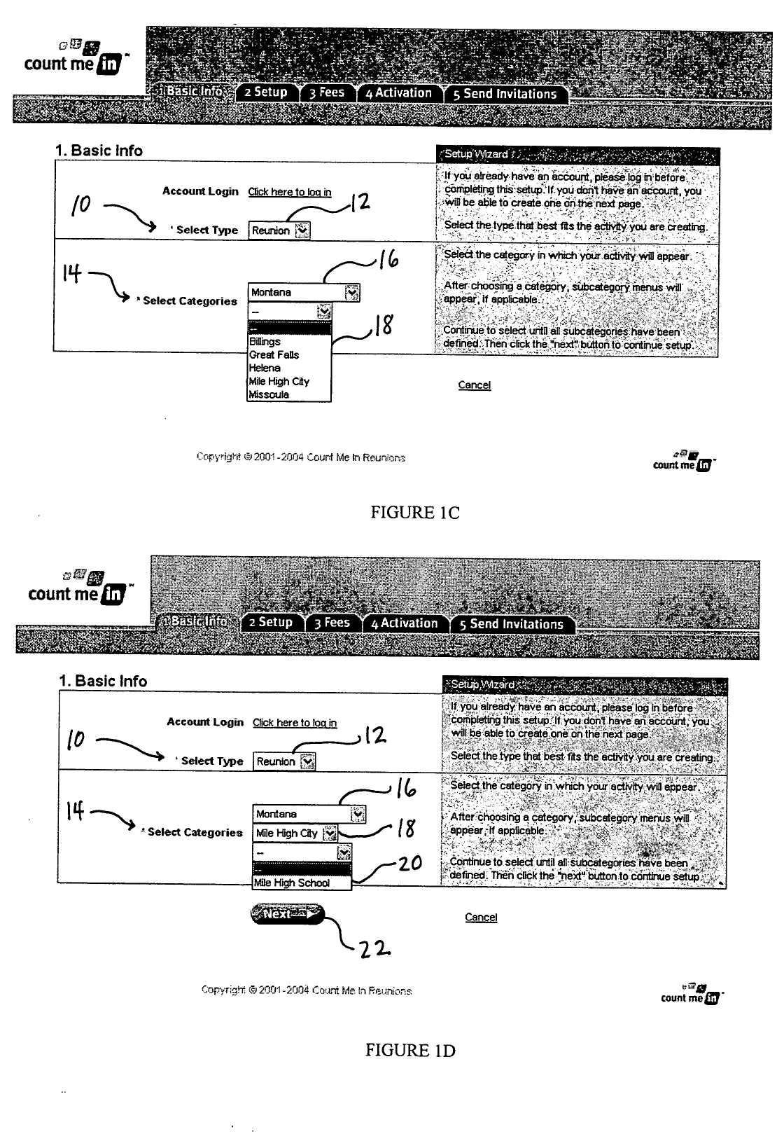

FIGS. 1-8 illustrate screenshots of a real-time event planning system according to one exemplary embodiment of the present invention. This particular embodiment, provided for illustrative purposes only, is directed to a reunion planning system and enables an event planner to create and publish reunion events via a computer network for registration.

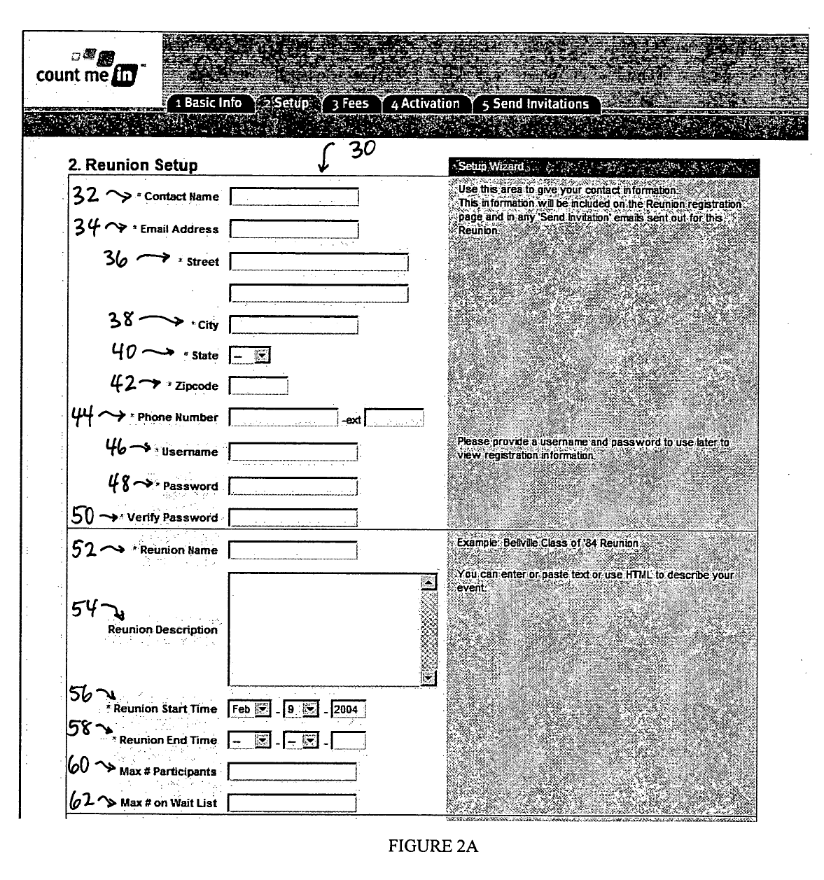

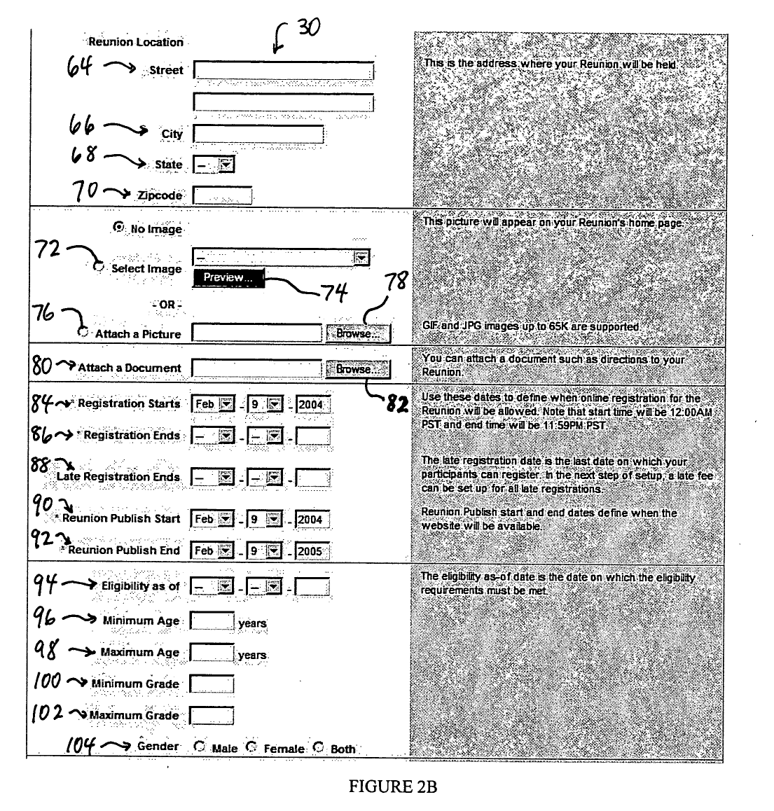

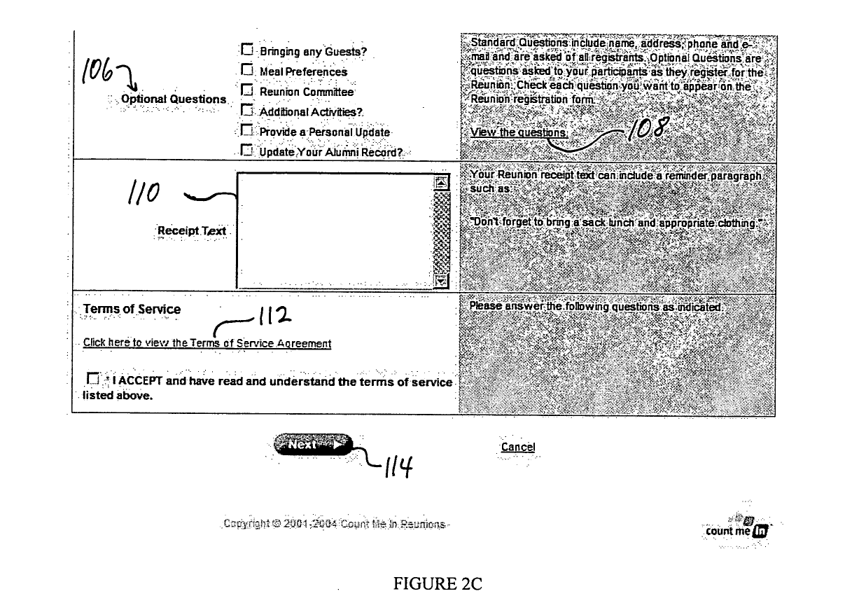

Embodiments of an event planning system provide an automated front-end interface and back-end database record creation and management process that enables an event planner to create and publish an event via a computer network. Depending on the particular implementation of the invention, the event planner can log into the event planning system if they already have an account, as noted in FIGS. 1A-1D. If the event planner does not have an account, the planner may create one using the interface depicted in FIGS. 2A-2C.

Embodiments of the invention are preferably configured to assist event planners set up different types of events. For example, in FIG. 1A, the event planner chooses the type of event they would like to set up using a Select Type drop down field 10. In this particular embodiment, the type of event is set to “Reunion,” as shown at reference numeral 12 in FIG. 1B. Other types of events may include, but are not limited to, sporting events, campouts, sport camps, association meetings, etc.

The event planner may next select a category 14 in which the event will occur. In the current “reunion” embodiment shown in FIG. 1B, the category is the state of the school or institution for which the reunion is being held. Other embodiments that encompass family or business reunions, for example, may use the category field to designate the state in which the reunion is located. After choosing a category (e.g., reunion state) 16, a subcategory drop down field 18 may appear listing cities located in that state, as shown in FIG. 1C. The event planner then selects the city for the reunion.

After choosing the city from the drop down field 18, another subcategory field 20 may appear listing high schools in that city, as shown in FIG. 1D. The event planner chooses the high school for which the reunion is being held. The real time categorization of the event allows the event to be properly listed in an event directory. Any number or types of categories may be used for categorizing the event.

The event planner clicks the “Next” button 22 to go to the reunion setup interface shown in FIGS. 2A-2C. The event planning system of the invention stores the basic information input thus far by the event planner. This information storage may be temporary, in anticipation of more formal database record creation at a later time, or the creation of database records for longer term storage of the information may immediately be initiated.

FIGS. 2A-2C depict a reunion setup interface 30 prepared in accordance with one embodiment of the invention. In FIG. 2A, the event planner provides his or her contact information. The event planner's name is entered in the field 32 labeled Contact Name, which in this embodiment is a required field (as indicated by an asterisk). The planner then enters their current email address in the field 34 labeled Email Address, their street address in the field 36 labeled Street, their city in the field 38 labeled City, their state in the drop down field 40 labeled State, their zipcode in the field 42 labeled Zipcode, and their phone number in the field 44 labeled Phone Number.

At this stage, the planner may be asked to provide a username 46 and password 48 to use later to log into the system. The planner enters a username in the field labeled Username, and a password in the field labeled Password. The planner reenters the same password in the field 50 labeled Verify Password.

The next section of the reunion setup interface 30 allows the planner to enter more detailed information about the reunion event. The name of the reunion is entered in the field 52 labeled Reunion Name, and detailed information about the reunion is entered in the field 54 labeled Reunion Description. This description may be entered using a markup language, such as HTML, to make it more visually appealing to the end user, if desired.

The planner chooses the reunion start time and end time by choosing the Month, Day, Year, Hour, Minute, and AM or PM from the drop down fields 56, 58 next to the labels Reunion Start Time and Reunion End Time, respectively. If desired, the planner may also enter a maximum number of participants that are allowed to register for the event in the Max # Participants field 60. This allows the planner to restrict the number of participants that can register for the event. This is not a required field in this embodiment, though it may be in others. When the event planning is completed and participants begin to register for the event, if the event planner has designated a maximum number of participants 60, the event planning system counts the number of registrations and accepts additional registrations until the maximum number is reached.

If the planner enters a maximum number of participants, the planner can also have a wait list created. If the number of participants seeking to register for the event reaches the maximum number, any new participants who try to register for the event will be notified and placed on the wait list. If a registered participant decides to cancel their registration, the first person on the wait list will automatically be moved off the wait list and on to the list of registered participants, preferably with appropriate notification being sent to the participant. The planner may enter a maximum number of people who can be on the wait list in the field 62 labeled Max # on Wait List.

The reunion setup interface 30 shown in FIG. 2A continues in FIG. 2B. In FIG. 2B, the planner enters information about the reunion location. The planner enters the street address of where the reunion will be held in the field 64 labeled Street. The planner enters the city where the reunion will be held in the field 66 labeled City. The planner chooses the state where the reunion will be held from the drop down field 68 labeled State. Lastly, the planner enters the zipcode of where the reunion will be help in the field 70 labeled Zipcode.

Publication of an event preferably includes providing a web site with an event home page available to potential participants, e.g., using HTML documents that can be transmitted and browsed via the Internet. A reunion's web site preferably includes the processes or links necessary to receive information from participants seeking to register for the event.

In the next section of the reunion setup interface 30, a planner can, in real time, add images to an event's home page. If the planner wants to add an image or graphic to the web site for the event, they can either choose to select an image from a library of public images 72 or attach a private picture of their own to the event web site. To select an image from a public library of images, the planner may select a radio button 72 as shown in front of the label Select Image. The planner then clicks on the drop down field labeled Select Image. The drop down field will display a list of available images. After the planner selects an image, the planner can preview the image by clicking on the button 74 labeled Preview.

If the planner wants to attach a picture from their own private library of images, the planner may select the radio button 76 in front of the label Attach a Picture. The planner would then click the button 78 labeled Browse to select a private image. The planner reviews his or her own pictures and selects the image to display on the reunion web site. In this particular implementation, the image must be less than 65 Kbytes, though other embodiments of the invention may be configured to accept images of different sizes. The image is then uploaded to the event planning server and stored in association with the database records for the event being created.

In the next section, the planner can attach a document to the reunion web site for later viewing or download by participants. By clicking on the Browse button 82 next to the field 80 labeled Attach a Document, the planner can browse their local client computer's hard drive or network and choose the document they would like to make accessible at the reunion's web site. An example would be to post the directions to the reunion in a document made accessible at the reunion's web site.

The planner can determine when the system is allowed to begin accepting registrations by setting when the registration starts. The planner chooses the registration start time by choosing the Month, Day, and Year from the drop down fields 84 next to the label Registration Starts. The planner chooses the registration end time by choosing the Month, Day, and Year from the drop down fields 86 next to the label Registration Ends. These dates define when registration for the reunion is allowed, and if the registration start time is set to a time at or preceding the time the event is created, the event (when created) becomes immediately available to participants to register. In embodiments, such as the one depicted in FIG. 2B, the hours of the start and end times may be assumed (e.g., starting 12:00AM PST and ending 11:59PM PST on the dates entered). In other embodiments, the hours of the start and end times may be explicitly entered by the planner.

Registrations received after the registration end date and time may still be accepted in a late registration period. The planner may set an ending date for the late registration period. The late registration ending date is the last date on which participants can register for the event. If desired, a late fee can be established for all late registrations. The planner chooses the late registration end time by choosing the Month, Day, and Year from the drop down fields 88 next to the label Late Registration Ends.

Reunion Publish Start and End dates, as shown in FIG. 2B, define the days when a web site for the reunion will be publicly available to potential participants. The planner chooses the reunion publish start time by choosing the Month, Day, and Year from the drop down fields 90 next to the label Reunion Publish Start. The planner chooses the reunion publish end time by choosing the Month, Day, and Year from the drop down fields 92 next to the label Reunion Publish End. Program code executable by a browser for displaying a reunion web site may be automatically generated using known scripts and software tools, and incorporate the event information provided by the event planner when creating the event.

In the next section, the planner can define eligibility requirements, if any, for the event. Eligibility requirements such as a minimum and maximum age and grade, as shown, may have greater applicability to event planning for other activities, such as youth sports. In any event, the eligibility as-of date is the date on which the eligibility requirements must be met. The planner may set the eligibility as-of date by selecting the Month, Day and Year in the drop down fields 94 next to the label Eligibility as of.

The planner may set the minimum and maximum ages of the participants by entering the ages, in years, in the fields 96, 98 labeled Minimum Age and Maximum Age, respectively. The planner also may enter the minimum and maximum grades of the participants by entering the numbers of the grades in the fields 100, 102 labeled Minimum Grade and Maximum Grade, respectively. If these fields are left blank, it may be assumed there is no minimum or maximum age or grade for eligibility. Again, fields such as these have greater applicability when planning activities such as youth sports.

The planner can further define the gender 104 of the participants that are able to register for the event. The planner selects the radio button next the label Male if the event is limited to male participants. The planner selects the radio button next to the label Female if the event is limited to female participants. If the event is open to all genders, the event planner selects the radio button next to the label Both. The selection of Both may be assumed and automatically filled, unless another selection is specified by the event planner.

In FIG. 2C, the event planner can add optional questions 106 to ask the participants when they register. Standard questions asked of participants, as noted above, request information such as name, address, phone and e-mail and are asked of all registrants, regardless of the event. Optional questions 106 are asked of participants when they register for the particular event being planned. In the illustrated embodiment, the event planner places a check next to each question he or she wants to appear on the reunion registration form. For example, if the planner wants to ask the participants whether they are bringing additional guests, the planner would check the box labeled Bring Additional Guests. If the planner wants to ask the participants if they have any meal preferences, the planner would check the box labeled Meal Preferences. If the planner wants to ask the participants if they would like to be on the reunion committee, the planner would check the box labeled Reunion Committee. If the planner wants to ask the participants if they want to add additional activities to the event, the planner would check the box labeled Additional Activities. If the planner wants to ask the participants to provide a personal update, the planner would check the box labeled Provide a Personal Update. Lastly, in the illustrated embodiment, if the planner wants to ask the participants if they want to update their alumni record, the planner would check the box labeled Update Your Alumni Record. A link 108 may be provided to a separate page providing the actual wording of the optional questions. Other embodiments of the invention may ask more, fewer, or different optional questions.

The next section in FIG. 2C allows an event planner to customize a message 110 that appears in a receipt provided to the event participant after they have completed their registration. For example, the receipt text for a reunion may include a reminder paragraph such as “Don't forget to bring a sack lunch and appropriate clothing”. The planner can enter or paste the text of a custom message into the field 110 labeled Receipt Text. After having an opportunity to review terms of service 112, the planner clicks the Next button 114 to continue to the event fees interface 120.

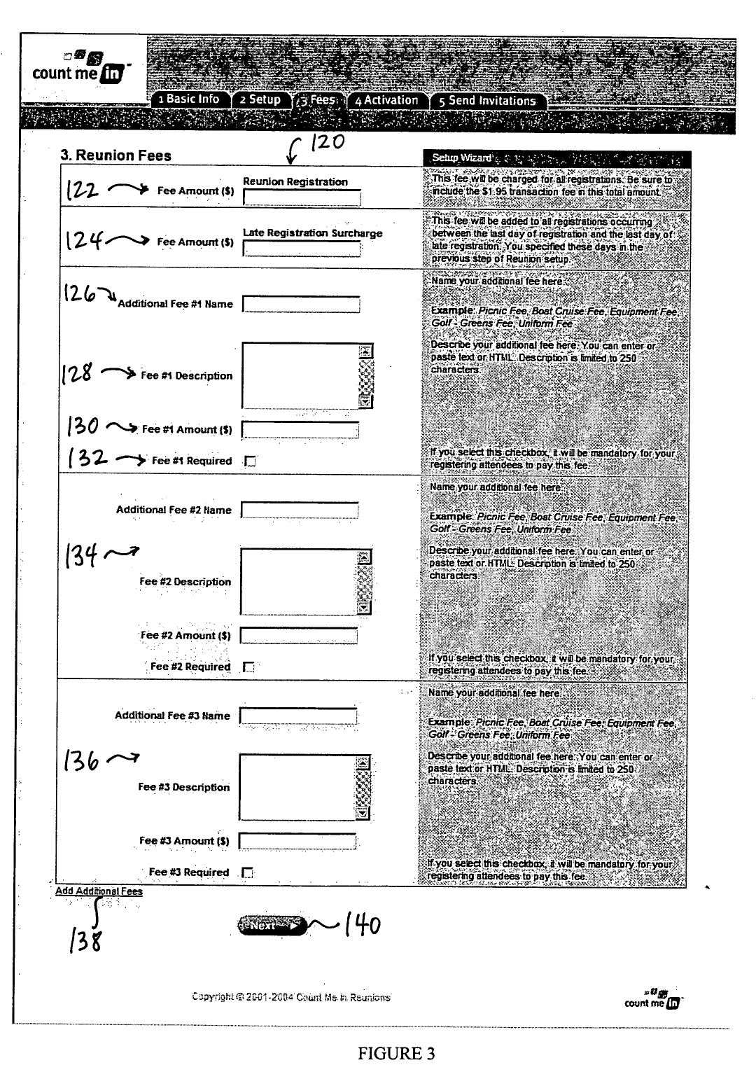

In FIG. 3, an event fees interface 120 is shown in which the event planner provides detailed information about registration fees for the reunion. The planner enters a base registration fee amount that will be charged to all registrants in the field 122 labeled Fee Amount ($) Reunion Registration. The planner may also enter a fee amount for late registration in the field 124 labeled Fee Amount ($) Late Registration Surcharge.

The next section of the event fees interface allows the planner to include fees for additional events at the reunion. For example, the reunion planner may add an optional picnic event, a golfing event, or a boat cruise event. The planner enters the name of the additional event fee in the field 126 labeled Additional Fee #1 Name. The planner then enters a detailed description of the additional event in the field 128 labeled Fee #1 Description. The fee amount for the additional event is entered in the field 130 labeled Fee #1 Amount ($). If payment of the additional fee is required of all registrants, the planner selects the check box next to the field 132 labeled Fee #1 Required. In the alternative, if the fee is not required, the event planner leaves the field 132 empty.

In the next two sections of FIG. 3, the event planner may add a second 134 and third 136 additional event description and fee. The planner may follow the same steps as with the first additional event to setup these additional event descriptions and fees. A link 138 may be provided as shown to enable the planner to add yet even further additional event fees, if desired. The event planner then clicks on the Next button 140 to proceed.

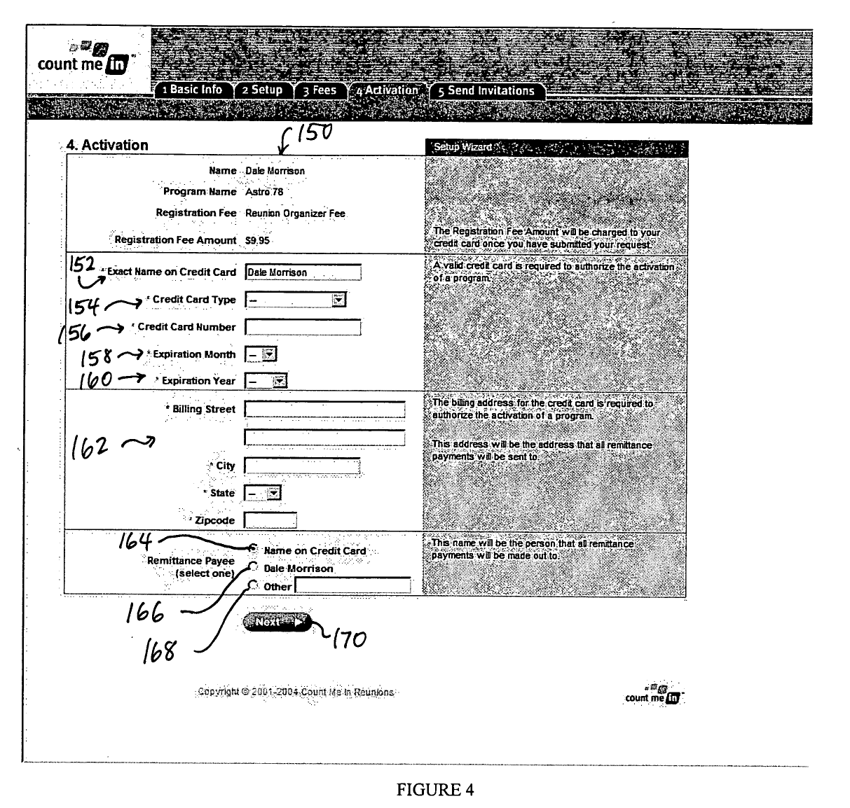

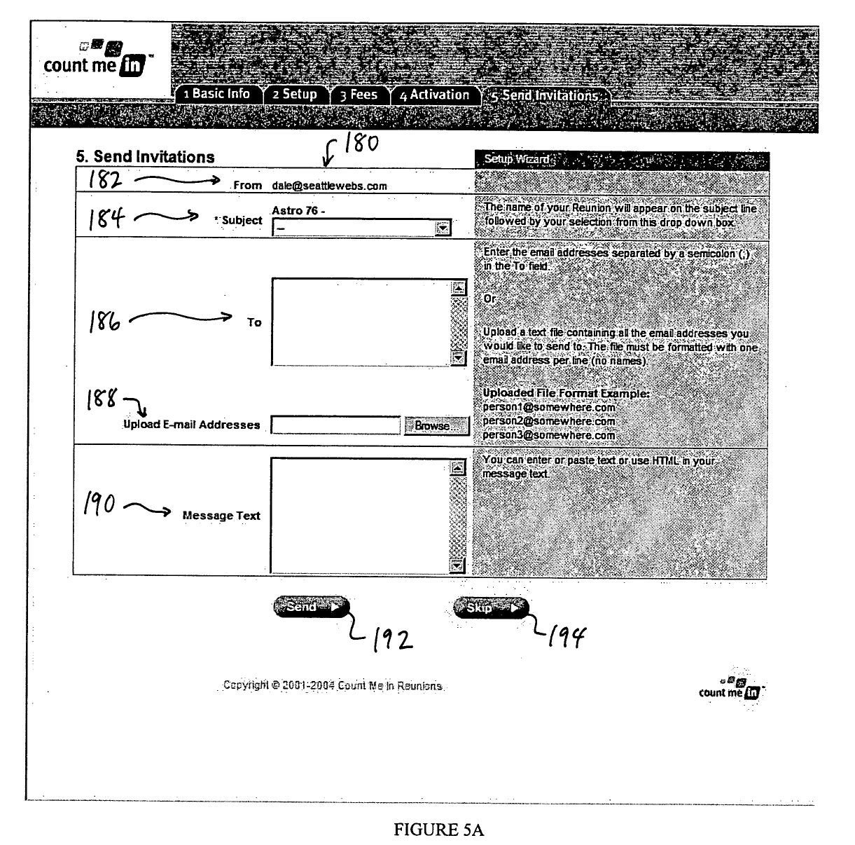

Turning now to FIG. 4, an activation payment interface 150 is shown in which the event planner may activate the reunion event that was set up using the event planning system described herein. The planner enters the name of the person whose credit card will be changed for the activation fee in the field 152 labeled Exact Name on Credit Card. The planner selects the credit card type from the drop down field 154 labeled Credit Card type and enters the credit card number in the field 156 labeled Credit Card number. The credit card expiration month and year are selected from the drop down fields 158, 160 labeled Expiration Month and Expiration Year, and the credit card billing address is entered in the fields 162 labeled Billing Street, City, State and Zipcode. The event planning system may use this address for remittance of all net payments received from registered participants.

In the next section of FIG. 4, the planner selects the name of the person to whom all remittance payments will be made for the registration fees collected. The planner selects the radio button 164 next to the field labeled Name of Person on Credit Card, if all remittance payments should be made to that person. Alternatively, the planner can select the contact name that is pre-populated from the information entered in the field labeled Contact Name (FIG. 2A) by selecting the radio button 166 next to the field with that contact name. Alternatively, the planner may enter the name to whom all remittance payments should be made by selecting the radio button 168 next to the field labeled Other and typing in the name of the person. The planner then clicks the Next button 170 to go to the email invitation 180 interface.

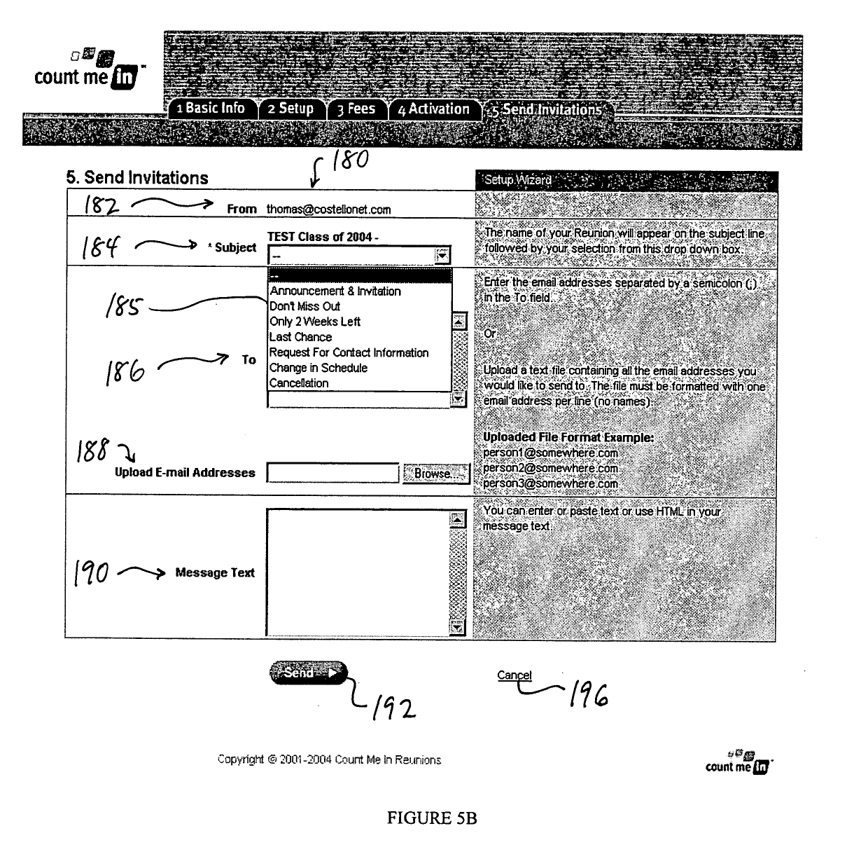

In FIGS. 5A and 5B, an email invitation interface 180 is shown which the event planner can use to send e-mail invitations to prospective participants. The planner may designate an e-mail address that will appear in the e-mail invitations as the originating address for the e-mail. If desired, the email address entered in the field 34 labeled Email Address in FIG. 2A may be pre-populated in FIG. 5A in the field 182 labeled From. This is the email address from which the email invitations will be appear to be sent. In other embodiments, the present invention allows event planners to easily associate a vanity e-mail address with the event in real time using the event planning system. For example, where the event planning system is used for setting up class reunions, the event planner may be presented with a drop down selection box with vanity e-mail domains, such as “classmatesof1984”, “classmatesof1985”, “classmatesof1986”, etc., for a wide range of years. Other event types may have different vanity e-mail domains registered by the event planning system and available for event planners to use in association with an event.

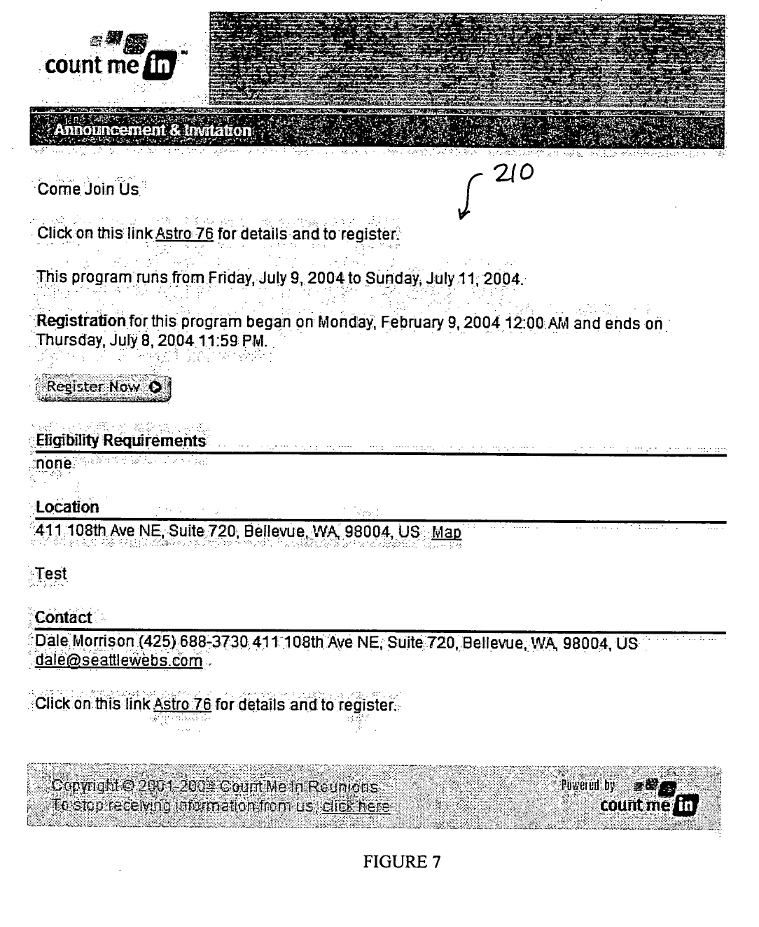

The subject of the email 184 may be set as the name of the reunion (previously entered in the field 52 labeled Reunion Name in FIG. 2A) followed by the type of email the planner wants to send (selected from the drop down field 185 labeled Subject shown in FIG. 5B). For example, if a planner for a reunion named “Class of 2004” wants to send an email with the subject “Announcement & Invitation,” the planner would select “Announcement & Invitation” in the Subject drop down box 185, and the subject line 184 of the email will be “Class of 2004-Announcement & Invitation”. FIG. 7 provides one example of an email 210 that may be sent to prospective event participants in accordance with the current embodiment described herein.

As illustrated in FIG. 5A, the planner may enter the email addresses of all prospective participants, preferably separated by a semi-colon or other marker, in the field 186 labeled To. In the alternative, the planner may upload a file 188 that contains a list of all prospective event participants' email addresses. The format of the uploaded file may be specified by the event planning system. For example, the planner may be informed that the uploaded file must contain only one email address per line. A browse button enables the planner to locate the file on a local disk or network. Typically the event planning system will include safeguards to preserve the confidentiality of any e-mail lists.

The planner then enters the body or content of the email in the field 190 labeled Message Text. The planner can enter or paste plain text into the Message Text field. Alternatively, the planner can enter or paste the message text in a markup language, such as Hypertext Markup Language (HTML). The planner clicks the Send button 192 to go to the confirmation and receipt interface. Alternatively, the planner can click a Skip button 194 or a Cancel link 196 if they do not want to send an email at the time of setting up the event. Preferably, the planner can return to an email invitation interface 180 at any time to send out an email, e.g., as shown by the link 236 in FIG. 9.

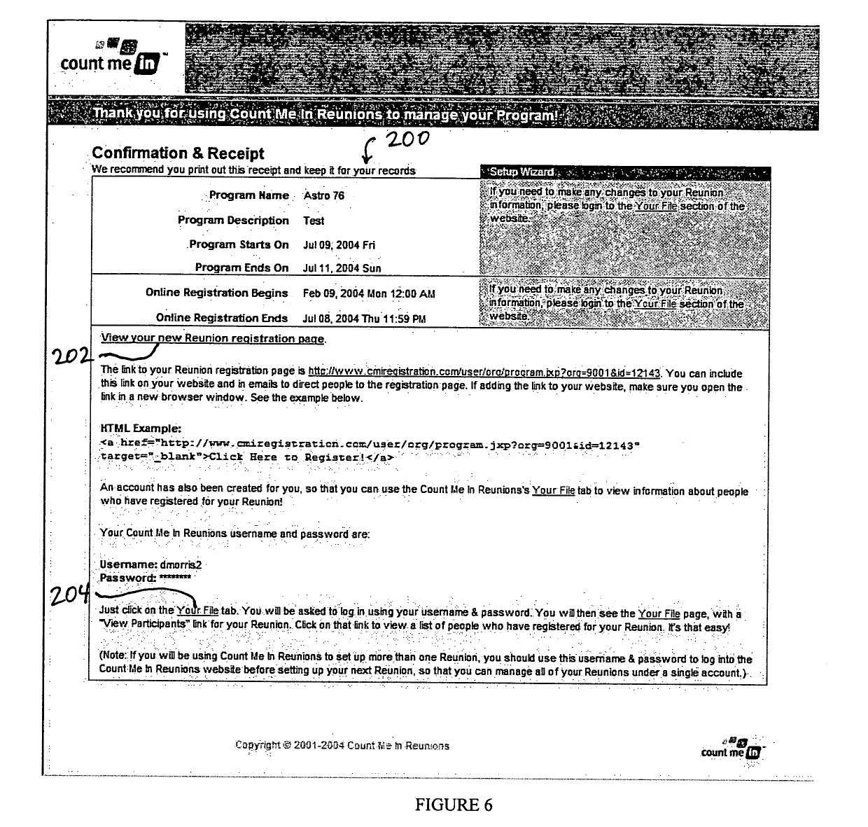

FIG. 6 depicts a confirmation and receipt interface 200 that may be provided by an event planning system of the invention. The event planner can use this interface to verify information that has been entered into the event planning system. As illustrated, the planner may click on a hypertext link 202 to view the reunion registration page that participants will see when they go to the reunion web site. The confirmation and receipt interface may also contain a link 204 to an interface, here called Your File, at which the event planner can modify in real time event characteristics entered into the event planning system. See FIG. 9 for an example of a Your File interface 230 in the current embodiment. Using the Your File interface 230, the planner can view all event participants who have registered for the event. Furthermore, the Your File interface 230 enables the event planner to download a list of all registered participants.

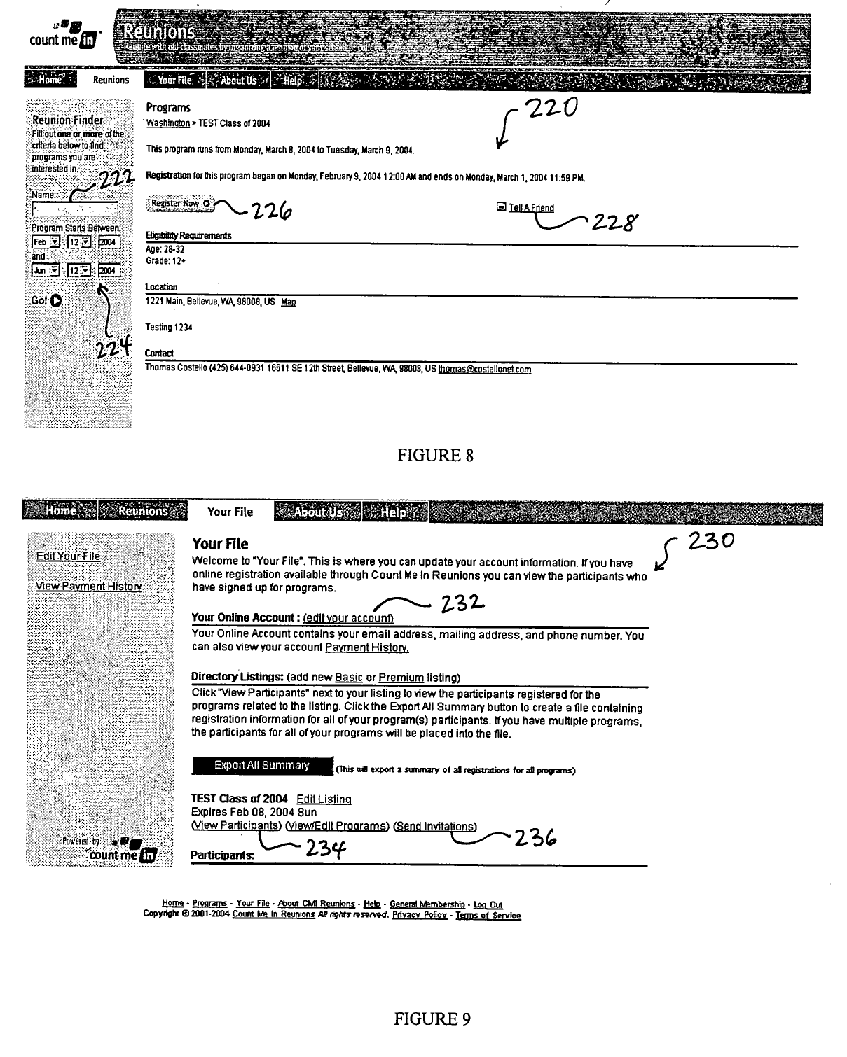

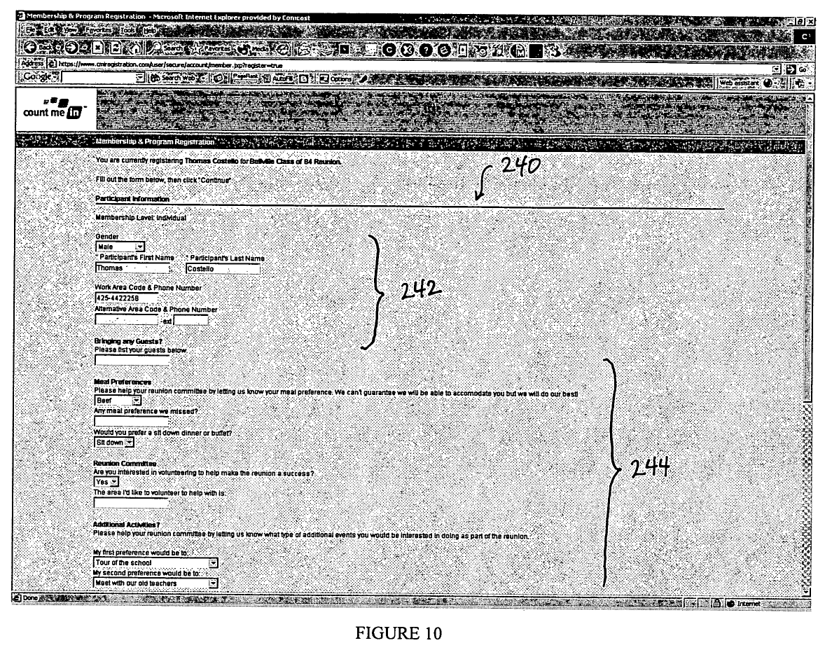

Once an event, such as a reunion, has been created and published, potential participants may search a database of all active events in the event planning system to identify a particular event of interest. The reunion finder interface 220 illustrated in FIG. 8 allows users to enter criteria, such as a reunion name 222 or an expected reunion start date 224, to search the database of active events. Events that match the user entered criteria are displayed, along with a Register Now button 226 that enables the user to access a registration page 240 (FIG. 10) for the event and complete the registration process. The event planning system also preferably provides a Tell a Friend feature 228, as shown in FIG. 8, that allows users to send event information to others, such as classmates, who may wish to be informed about the event.

FIG. 9 depicts an example of a “Your File” interface 230 that provides an event planner with a link 232 to information concerning the planner's account. It also provides a link 234 to view all of the participants registered for programs (events) organized within the planner's current listing. Software processes built into the present invention provide reports identifying registered participants so event planners can monitor the status of the event registrations in real time. The information is drawn directly from the event registration database. Again, this functionality is built into the system and is available to event planners without requiring external program downloads or live assistance.

FIG. 10 depicts an event registration interface 240 that a participant may use to register for an event. In addition to requesting basic information 242 identifying the participant, the registration interface 240 is configured to ask any customized questions 244 included by the event planner in the program when the event was set up in the system. When the participant has finished filling out the registration interface, the participant clicks on a “Continue” button (not illustrated).

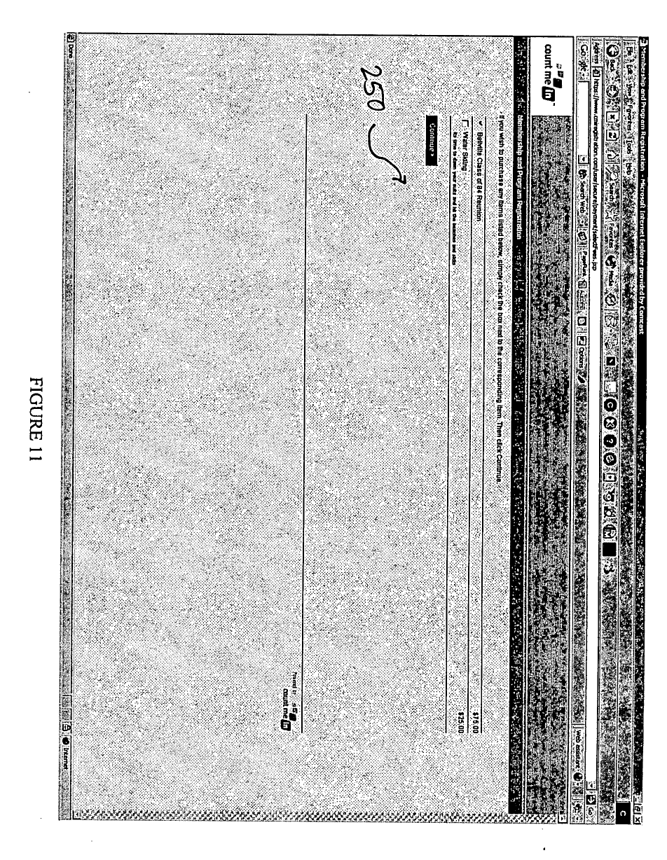

Preferably, before entering a registration fee payment interface, the participant is given an opportunity to review the fees that the participant will be requested to pay. This includes the basic registration fee for the event, that is required of all participants, and any fees associated with additional activities in which the participant elected to take part. FIG. 11 depicts a sample event registration fees summary 250 that may be presented for confirmation by a registering participant. Clicking the Continue button 252 confirms the agreement to pay the fees.

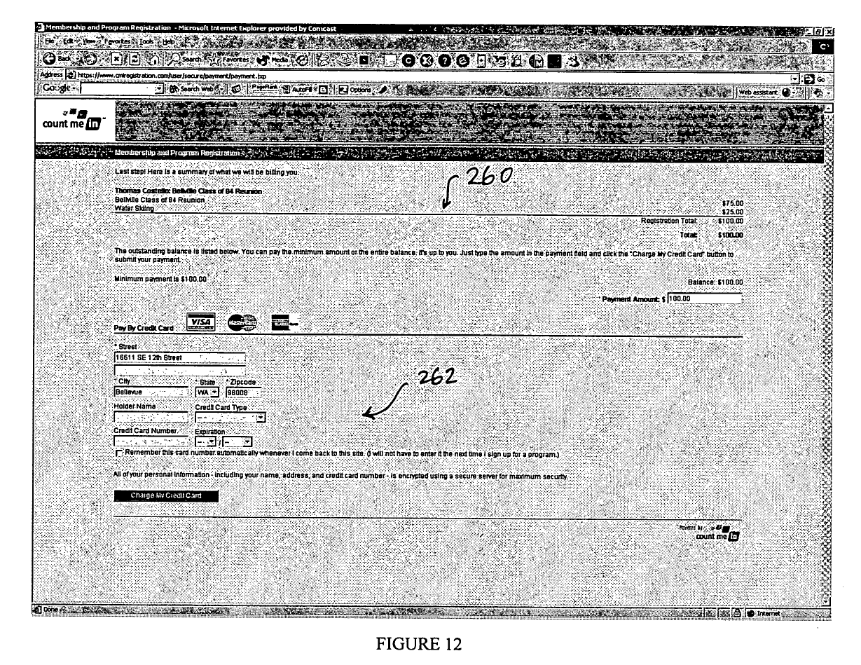

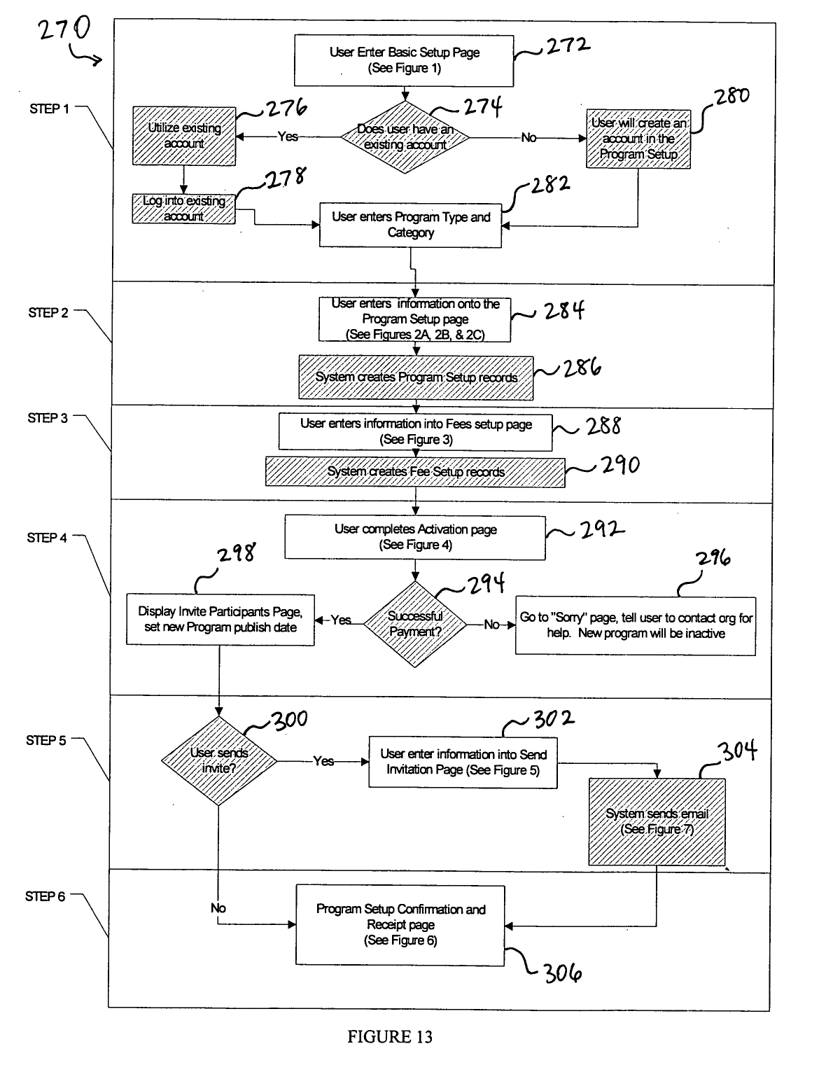

FIG. 12 depicts an exemplary event fees payment interface 260 that participants may use to pay registration fees for an event. The total fees are featured, along with data entry field 262 for entry of credit card information if payment by credit card is desired. Optionally, the participant may indicate that the fees will be paid offline, e.g., by mailing a check or money order.

Turning now to FIG. 13, a system flow diagram 270 is provided and describes one embodiment of a real-time event planning method that can be used in connection with the event planner interfaces shown in FIGS. 1-8.

In STEP 1 of the flow diagram 270, the event planner/user accesses the event planning system, e.g., using a client computer to access an Internet website operating on an event planning server. At reference box 272, a browser operating on the client computer receives a basic information setup page from the event planning server, e.g., as depicted in FIGS. 1A-1D, and displays the setup page to the user for entry of information. Using the information provided by the user, the event planning server determines at decision box 274 whether the user has an existing account with the event planning system. If so, the event planning server utilizes the user's existing account at box 276 and logs the user into the account at box 278. Otherwise, the user is prompted at box 280 to create an account in a program (event) setup interface to be provided to the user. In either case, the event planning server prompts the user at reference box 282 to select or otherwise enter information that identifies the program type and category, e.g., a city, state and high school for a reunion event, as described earlier in regard to FIGS. 1B, 1C and 1D.

In STEP 2 of FIG. 13, the event planning server provides the user with a program (event) setup interface, an example of which was described earlier with respect to FIGS. 2A-2C. Depending on the type and format of the event, the event setup interface may query the user for different information to identify the features and characteristics of the event, such as the event start and end times, location, registration times, eligibility requirements, etc. As described earlier in regard to FIG. 2B, the processes executing at the event planning server to provide the event setup interface may enable the user to associate an image or a document with the event when the event is published to potential participants. Given the event information provided by the user at box 284, the event planning server may use known database tools at box 286 to create program setup records in an event database to store the event information.

In STEP 3 of FIG. 13, the event planning server provides the user with an event fees interface, which may be in the form of a Web page for example, that queries the user for information concerning a base fee for the event that is charged to all participants and/or fees for additional activities that may be required of some or all participants. An example of an event fees interface was described earlier with respect to FIG. 3. Again, given the information provided by the user at box 288, the event planning server creates additional database records at box 290 to store the event fee information.

In STEP 4, the event planning server provides the user with an activation payment interface that enables the user to activate the event for registration by others. One example of a Web page for event activation is depicted in FIG. 4, as earlier described. Upon completion of the activation page at box 292, the event planning server determines at decision box 294 whether payment from the user for the event activation was successful. If not, the event planning server may deliver a “sorry” Web page at box 296 that informs the user of the problem and asks the user to contact the organization providing the event planning system for assistance. A program set up by an event planner that is not successfully activated remains inactive, though the information provided by the planner may be retained by the event planning server. Otherwise, if the activation payment was successful, the event becomes active and if within the registration start and end times, the event is immediately available for registration. The event planning server may provide the user with an e-mail invitation interface at box 298 that helps the user develop an invitation that can be sent to potential participants. The event planning server notes the date at which the program or event will be formally published based on information previously received from the user in STEP 2.

In STEP 5 of FIG. 13, at decision block 300, the event planning server determines whether the user wishes to send event invitations to potential participants. If so, the user is prompted at box 302 to enter information into the e-mail invitation interface, e.g., as shown in FIG. 5, after which the event planning server at box 304 generates and sends the e-mail to the prospective participants. As noted earlier, an example of an e-mail invitation is provided in FIG. 7.

Lastly, at box 306 in STEP 6, the event planning server provides the user with a confirmation and receipt interface, regardless of whether the user sends e-mail invitations at that time. An example of a Web page providing a confirmation and receipt interface in this regard is shown in FIG. 6. Concurrently, or previously, the event planning server may generate program code for a website specific to the event providing potential participants all of the details concerning the event along with a registration page. A link to the event registration page may be provided to the user in the confirmation and receipt interface to enable the user to verify the information that potential participants will see at the event website, as shown in FIG. 6. If the user is sending separate e-mails to potential participants, the user may cut and paste the link to the event registration page when sending the e-mails.

The following tables describe various exemplary database records and fields in those records that may be populated with information gathered from an event planner in the process of creating an event for publication and registration by others. The tables describe one particular implementation and illustrate a currently preferred embodiment of the invention. Other embodiments of the invention may use different database structures and queries to obtain information from event planners for purposes of creating the database records that support a real-time event planning system. As noted earlier, one of the advantages of the preferred embodiment is that the event planner is able to create and publish an event in real time, without needing to download and execute external programs or obtain live assistance from others for entry of event information and creation of back-end database records.

Page: Please Select your Program Type

| | Visible on | | | |
|---|---|---|---|---|
| | Select your | | | |
| | ProgramType | Data Input | | |
| Table column name | page? | Field | Functionality | Notes |
| Program.programtypeid | Yes | Select Program | Required. The program | The field labels |
| | | Type (drop | owner selects the best-fit | on the Tell Us |
| | | down) | program type for their | about Your |
| | | | program they are creating. | Program page are |
| | | | The drop-down list box is | set based on the |
| | | | populated by selecting from | Label attribute of |
| | | | organizationprogramtype, by | the selected |
| | | | organization id, to display | programtype. |
| | | | valid program types to select | |
| | | | from | |
| Program.parentcategoryid | Yes | Select Program | Required. All programs | Only show |
| | | Categories (drop | must belong to a parent | categories in the |
| | | down) | category. If the first | drop-down list |
| | | | category selected has “child” | boxes which are |
| | | | categories, display a second | currently being |
| | | | drop-down box below the | published to the |
| | | | first to display those child | website (within |
| | | | category selections, and so | their publish |
| | | | on. If a parent category has | start/stop date |
| | | | child categories, the program | range or flagged |
| | | | owner must select one of the | as “never |
| | | | child categories - we do not | expire”). |
| | | | allow programs and | |
| | | | categories to exist at the | |
| | | | same “level”. Continue to | |
| | | | add drop-down boxes to | |
| | | | display child categories until | |
| | | | you are at the lowest tier of | |
| | | | the category tree for the | |
| | | | selected path. The final | |
| | | | selected level of the | |
| | | | category tree will be the | |
| | | | parentcategoryid set for the | |
| | | | program. | |

Page: Tell Us About Your <label> (default to “Program” if <label> is not set)

| | Visible on | | | |
|---|---|---|---|---|
| | Program | Data Input | | |
| Table column name | setup page? | Field | Functionality | Notes |
| listing.contactname, | Yes | <label> Contact | Required. | Currently, this |
| member.firstname, | | Name | | information is |
| member.lastname | | Default to | | stored in the |
| | | “Program” if | | listing. |
| | | <label> is blank | | |
| Account.email, listing.email | Yes | Contact e-mail | | |
| Account.street | Yes | Contact Street | Required (except street2). | |
| | | address | | |
| Account.street2 | | Street address 2 | | |
| Account.city | | City | | |
| Account.state | | State | | |
| Account.zip | | Postal Code | | |
| Listing address fields | | | | |
| Account.homephone | Yes | Contact phone | Required. | |
| Listing.mainphone | | number | | |
| Account.username | Yes | User Name | Required for new accounts. | Put text in the |
| | | | Do not display this entry | “Notes” area that |
| | | | field if the user is logged in. | the username and |
| | | | Use same uniqueness & | Password are |
| | | | validation rules as on the | used to come |
| | | | Account.jxp page. | back to the |
| | | | | website to view |
| | | | | information about |
| | | | | the participants |
| | | | | registered for |
| | | | | your programs. |
| Account.passwordencrypted | Yes | Password | Required for new accounts. | |
| | | | Do not display this entry | |
| | | | field if the user is logged in. | |
| | | | Use same uniqueness & | |
| | | | validation rules as on the | |
| | | | Account.jxp page. | |
| | Yes | Verify Password | Must match the other | |
| | | | password field. | |
| Program.Name, | Yes | <label> Name | Required. | |
| Listing.orgname | | (Default to | | |
| | | “Program” if | | |
| | | <label> is not | | |
| | | populated | | |
| Program.Contentid | YES | <label> | Required. | The program |
| | | Description | Need to create a separate | description. In a |
| | | (Default to | content record for this, | preferred |
| | | “Program” if | potentially even some | embodiment, an |
| | | <label> is not | additionalcontent record(s) | HTML- |
| | | populated) | as well if the description is | generation tool is |
| | | | sufficiently long. | provided so the |
| | | | | program owner |
| | | | | can use standard |
| | | | | word-processor |
| | | | | formatting & |
| | | | | have it |
| | | | | “translated” into |
| | | | | HTML behind- |
| | | | | the-scenes. |
| Program ProgramStart | Yes | <label> Start | Required, default to current | Easy-to-use date |
| | | Time | date. | controls are |
| | | | | preferred. |
| Program ProgramStop | Yes | <label> End | Required, default to null. | Easy-to-use date |
| | | Time | | controls are |
| | | | | preferred. |
| Program.maximumparticipants | Yes | Maximum # | | Default is null, an |
| | | participants | | unlimited number |
| | | | | of participants. |
| Program.maximumwaitlist | Yes | Maximum # on | | Default is null, an |
| | | waitlist | | unlimited number |
| | | | | of people on the |
| | | | | waitlist. |
| Program.street | Yes | <label> location | These fields are not required, | Where the |
| | | (Default to | but if street is filled in then | program is being |
| | | “Program” if | the other fields are required | held. Display this |
| | | <label> is not | as well (other than street2). | information on |
| | | populated) | However, city, state & zip | the Program |
| Program.street2 | | Street Address | may be filled in without any | Detail page, |
| Program.city | | City | street information. | along with a |
| Program.state | | State | | mapping link, if |
| Program.zipcode | | Postal Code | | the address has |
| | | | | been populated. |
| | | | | If the address is |
| | | | | null, do not |
| | | | | display the |
| | | | | mapping link on |
| | | | | the Program |
| | | | | Detail page. |
| | | | | (requires changes |
| | | | | to the Program |
| | | | | Detail page). |
| Programcode | No | Account.username - | | Prefixing the |
| | | Program.name | | program name |
| | | | | with the account |
| | | | | username will |
| | | | | hopefully allow |
| | | | | grouping of |
| | | | | programs by |
| | | | | program owner |
| | | | | on the remittance |
| | | | | report, rather than |
| | | | | having them just |
| | | | | scattered |
| | | | | randomly |
| | | | | throughout the |
| | | | | remittance report. |
| Content.mediaid | YES | Select a picture | Used to set media id on the | In one |
| | | | content record, based on the | embodiment, this |
| | | | selection of an existing | is mutually |
| | | | media record. | exclusive with the |
| | | | If no images have been | “Attach a picture” |
| | | | loaded for the organization, | feature. The user |
| | | | do not show this option. | can either select |
| | | | | an existing image |
| | | | | or attach one, not |
| | | | | both. |
| Media.mediaid & | YES | Attach a picture | Used to create a media | In one |
| | | | record and set media id. | embodiment, this |
| Content.mediaid | | (attach button) | Should open a standard | is mutually |
| | | | windows “finder” to browse | exclusive with the |
| | | | to an image and attach it. | “Select a picture” |
| | | | | feature. The user |
| | | | | can either select |
| | | | | an existing image |
| | | | | or attach one, not |
| | | | | both. |
| Media.mediaid | YES | Attach a | Used to create a media | Should open a |
| | | document | record and set media id. | standard windows |
| | | | | “finder” to |
| Content.documented | | (attach button) | Should open a standard | browse to an |
| | | | windows “finder” to browse | document and |
| | | | to a document and attach it. | attach it. |
| Program.RegistrationStart | Yes | Registration | Required, default to current | Easy-to-use date |
| | | Starts | date. | controls are |
| | | | | preferred. |
| Program RegistrationStop | Yes | Registration | Required, default null. | Easy-to-use date |
| | | Ends | | controls are |
| | | | | preferred. |
| Program LateRegistrationStop | Yes | Late | | Easy-to-use date |
| | | Registration | | controls are |
| | | Ends | | preferred. |
| Program PublishStart | Yes | <label> Publish | Required, default to current | Easy-to-use date |
| | | Start (Default to | date. | controls are |
| | | “Program” if | | preferred. |
| | | <label> is not | | |
| | | populated) | | |
| Program PublishStop | Yes | <label> Publish | Required, default to current | Easy-to-use date |
| | | End (Default to | date + 1 year. | controls are |
| | | “Program” if | | preferred. |
| | | <label> is not | | |
| | | populated) | | |
| Program.eligibilityasofdate | YES | Eligibility as-of: | Default Eligibility as-of date | Easy-to-use date |
| | | | to the current date, and | controls are |
| | | | always set eligibility as-of | preferred. |
| | | | date in the program record. | |
| | | | If no eligibility criteria are | |
| | | | specified by the program | |
| | | | creator, don't set them in the | |
| | | | program record. | |
| Program.minimumage | YES | Minimum & | | Eligibility |
| Program.maximumage | | Maximum Age | | requirements |
| Program..minimumgrade | YES | Minimum & | | |
| Program.maximumgrade | | Maximum | | |
| | | Grade | | |
| Program.requiredgender | YES | Gender | | |
| | | (male/female | | |
| | | selector) | | |
| Programform.programid/ | yes | Additional | Used to | Preferably, the |
| programform.formid | | Questions on the | create a | notes area will |
| | | Registration | ProgramForm | have a link to a |
| | | Form: | record. | popup that will |
| | | Assume a pre- | As for participant-type | show a list of the |
| | | defined set of | forms, a flag or type of form | questions that |
| | | question forms/ | may be used to indicate | will be asked for |
| | | questions. A | whether or not the form | each form. |
| | | user interface | should be displayed in this | |
| | | allows the | list. Some participant-type | |
| | | program owner | forms may be very specific | |
| | | to associate 0, 1 | to a certain program-owner | |
| | | or more of the | and not desirable for | |
| | | pre-defined | selection by other program | |
| | | forms with a | owners. These would be | |
| | | program. | assigned to their program(s) | |
| | | However, | within the admin tool, which | |
| | | instead of hard- | is ok. | |
| | | coding the list of | | |
| | | forms to use, | | |
| | | this should pull | | |
| | | from | | |
| | | questionform, | | |
| | | by | | |
| | | organizationid. | | |
| Program.receiptcontentid/ | Yes | Receipt text | | Help/notes copy |
| | | | | should say |
| | | | | something like “Is |
| | | | | there any specific |
| | | | | content/copy that |
| | | | | needs to display |
| | | | | on the receipt for |
| | | | | this <label>? |
| | | | | (Default to |
| | | | | “Program” if |
| | | | | <label> is not |
| | | | | populated)”. |
| Content.text | | | | In a preferred |
| | | | | embodiment, an |
| | | | | HTML- |
| | | | | generation tool is |
| | | | | provided so the |
| | | | | program owner |
| | | | | can use standard |
| | | | | word-processor |
| | | | | formatting & |
| | | | | have it |
| | | | | “translated” into |
| | | | | HTML behind- |
| | | | | the-scenes. |
| Note that it may be advantageous to add flex-form/answermap capability to the program table, in case the event planner wants to gather additional information about the program that is not supported in standard database fields. These capabilities may be presented after the Receipt Text field. There may or may not be any Help/Notes text available for these | | | | |
| # questions, depending on how the admin tool is specified. The questions for each form should be displayed in a separate “box”, if there is a title defined for the form. That title would appear above the questions. | | | | |

| | | | | |
|---|---|---|---|---|
| | Visible on | | | |
| | Reunion | | | |
| Table column name | setup page? | Data Input Field or Static value | Functionality | Notes |

Setup Fees page

| | | | | |
|---|---|---|---|---|
| Fee.name | YES | Standard | Set fee & membershiplevel | Create |
| | | Registration Fee: | fee fields as follows: | membershiplevelfee |
| | | Fee amount | Name - same as program | records for all |
| | | | name | active |
| Fee.description | | | Description - null | membership |
| Fee.required | | | Required - 1 (true) | levels defined for |
| Fee.active | | | Active - 1 (true) | the organization. |
| Fee.Feetypeid | | | Amount - populated by | The amount fields |
| | | | “amount” text box | (amount, |
| Membershiplevelfee.amount | | | Membershiplevel - all (see | minimumpayment |
| | | | notes) | amount, |
| Memberhsiplevelfee.membershiplevelid | | | Feetypeid - 2 | depositamount) |
| | | | | will be the same |
| Membershiplevelfee.minimumpaymentamount | | | Min payment amount - same | for all of the |
| | | | as “amount” | membershiplevelfee |
| Membershiplevelfee.depositamount | | | Deposit amount - same as | records |
| | | | “amount” | created. |
| Fee.name | YES | Late | Set fee & membershiplevel | Create |
| | | Registration Fee: | fee fields as follows: | membershiplevelfee |
| | | Fee Amount | Name - same as reunion | records for all |
| | | | name + “Late Fee” | active |
| Fee.description | | | Description - null | membership |
| Fee.required | | | Required - 1 (true) | levels defined for |
| Fee.active | | | Active - 1 (true) | the organization. |
| Fee.Feetypeid | | | Amount - populated by | The amount fields |
| | | | “amount” text box | (amount, |
| Membershiplevelfee.amount | | | Membershiplevel - all (see | minimumpayment |
| | | | notes) | amount, |
| Memberhsiplevelfee.membershiplevel | | | Feetypeid - 3 | depositamount) |
| | | | | will be the same |
| Membershiplevelfee.minimumpaymentamount | | | Min payment amount - same | for all of the |
| | | | as “amount” | membershiplevelfee |
| Membershiplevelfee.depositamount | | | Deposit amount - same as | records |
| | | | “amount” | created. |
| For additional fees | | | | Display |
| | | | | additional fee |
| | | | | fields on the |
| | | | | page, possibly |
| | | | | with a link or |
| | | | | button option to |
| | | | | add more. |
| Fee.name | yes | Additional Fee | | |
| | | name | | |
| Feetypeid | NO | set to static | | |
| | | value ‘2’ | | |
| | | (program fee) | | |
| Fee.description | Yes | Fee Description | | |
| Membershiplevelfee.amount | Yes | Fee Amount | | |
| Fee.required | Yes | Required Fee | | |
| | | (radio button) | | |
| Fee.active | No | 1 (true) | | |
| Membershiplevelfee.membershiplevel | no | All (see notes) | | Create |
| | | | | membershiplevelfee |
| | | | | records for all |
| | | | | active |
| | | | | membership |
| | | | | levels defined for |
| | | | | the organization. |
| | | | | The amount fields |
| | | | | (amount, |
| | | | | minimumpayment |
| | | | | amount, |
| | | | | depositamount) |
| | | | | will be the same |
| | | | | for all of the |
| | | | | membershiplevelfee |
| | | | | records |
| | | | | created. |
| Membershiplevelfee.minimumpaymentamount | No | Membershiplevel | | Preferably set to |
| | | fee.amount | | the fee amount. |
| Membershiplevelfee.depositamount | No | Membershiplevel | | Preferably set to |
| | | fee.amount | | the fee amount. |
| | Yes | Add Additional | Adds another Additional Fee | If the information |
| | | Fees link | “block” at the end of the | for an additional |
| | | | page. Same or similarl | fee “block” is |
| | | | attributes and functionality | null, just ignore |
| | | | as listed above. The | it. |
| | | | program owner should be | |
| | | | able to add as many fees as | |
| | | | they want to, by clicking the | |
| | | | Add Additional Fees link | |
| | | | multiple times. | |
| | Yes | Submit Button | Creates a program record. | Go to the |
| | | | Creates a content record for | Program Setup |
| | | | the program description. | thank-you page |
| | | | Creates a content record for | when finished. |
| | | | the receipt content, if | |
| | | | entered. | |
| | | | Creates fee record for each | |
| | | | specified fee. | |
| | | | Creates membershiplevelfee | |
| | | | records for each specified | |
| | | | fee. | |
| | | | Creates a media record if an | |
| | | | image is attached. | |
| | | | Creates a media record if a | |
| | | | document is attached. | |
| | | | Creates a programform | |
| | | | record for each optional form | |
| | | | selected (assumes all forms | |
| | | | are pre-existing). | |
| | | | Creates an account for the | |
| | | | reunion organizer. | |
| | | | Creates a “hidden” listing for | |
| | | | the reunion organizer's | |
| | | | account (not published). | |
| | | | Create a ProgramListing | |
| | | | record to link the “hidden | |
| | | | listing” to the program | |
| | | | (provides very basic | |
| | | | reporting capability via the | |
| | | | website). | |
| | | | Sends an e-mail to the | |
| | | | Reunion organizer/planner | |
| | | | confirming the creation of | |
| | | | their Reunion program. | |
| | Yes | Cancel Link | Cancels the program setup | Go to the event |
| | | (not shown on | process. | planning system's |
| | | the comp) | | home page for the |
| | | | | event planner. |
| | | | | Preferably, this |
| | | | | would re-set the |
| | | | | program publish |
| | | | | date(s) so that the |
| | | | | program is not |
| | | | | published (i.e. |
| | | | | does not display |
| | | | | on the |
| | | | | organization's |
| | | | | website), |
| | | | | although it will |
| | | | | continue to |
| | | | | appear in the |
| | | | | event planners |
| | | | | admin tool. |
| | YES | Cancel link | Do not insert the program, | |
| | | | return to the event planning | |
| | | | system home page for the | |
| | | | event planner. | |
| | YES | Next button | Go to the Program Fees | |
| | | | page, save program setup | |
| | | | first. | |

Additional database fields not shown on the webform in the current embodiment

| | | | |
|---|---|---|---|
| Program.ProgramId | No | Program_seq.nextval | Generated |
| Program.Description | NO | null | |
| Program.Adult | No | 1 | Static value |
| Program.Minimumweight | No | Null | |
| Program.Maximumweight | No | Null | |
| Program.Minimumheight | No | Null | |
| Program.Maximumheight | No | Null | |
| Program.SkillRequired | No | Null | |
| Program.AdminNotes | No | Null | |
| Program.InsertedBy | No | ‘WEB2Website’ | Static value |
| Program.InsertedDate | No | Current | |
| | | date/time stamp | |
| Program.ModifiedBy | No | Null | |
| Program.ModifiedDate | No | Null | |
| Program.OrganizationId | No | Org ID from the | |
| | | URL string | |
| Program.TeamRosterViewable | No | 0 | Not applicable in |
| | | | this embodiment |
| Program.Allowvolunteers | No | 0 | If an event |
| | | | planner wants to |
| | | | ask for |
| | | | volunteers, they |
| | | | can use a std |
| | | | participant flex- |
| | | | form question |
| Program.Mediaid | NO | null | |
| Program.Allowdonation | No | 0 | Static value |
| Program.Sponsoramount | No | Null | |
| Program.Teamvolunteerviewable | No | 0 | Static value |
| Program.Teamschedulesviewable | No | 0 | Static value |
| Program.Imagealignment | NO | “Right” | Static value |
| Program.Archived | No | 0 | Static value |
| Program.Archiveddate | No | null | |
| Program.Teamrosterviewablebyfolunteers | No | 0 | Static value |
| Program.Sortorder | No | Null | Allow this to |
| | | | default to |
| | | | alphabetical order |
| Program.Paidmembershiprequired | No | 0 | |
| Program.Statisticsid | No | NULL | |
| Account.accountid | No | Account_seq.nextval | |
| Account.organizationid | No | Same as | |
| | | program.organizationid | |
| Account.Savepaymentinfoid | No | Null | |
| Account.Passwordencrypted | No | Set based on | |
| | | password | |
| | | entered by the | |
| | | program owner | |
| Account.Passwordreminder | No | NULL | |
| Account.householdsize | No | Null | |
| Account.adminnotes | No | Null | |
| Account.insertedby | No | ‘Web2Website’ | Static value ok |
| Account.inserteddate | No | Current | |
| | | date/time | |
| Account.modifiedby | No | Null | |
| Account.modifieddate | No | Null | |
| Account.emailsubscriber | No | 1 | Default to TRUE |
| Account.answermap | NO | null | |
| Account.autologin | No | 0 | |
| Account.secondaryemail | No | Null | |
| Account.blocked | No | 0 | Default to false |
| Account.parentaccountid | No | Null | |
| Account.corporate | No | 0 | Default to false |
| Account.corporatename | No | null | N/a for program |
| | | | setup |
| Account.corporatecode | No | Null | N/a for program |
| | | | setup |
| Listing.listingid | No | Listing_seq.nextval | Only create a new |
| | | | listing if the |
| | | | account does not |
| | | | already have one. |
| Listing.organizationid | No | Same as | |
| | | program.organizationid | |
| Listing.accountid | No | Accountid for | This could be a |
| | | the program | new accountid if |
| | | owner | the account was |
| | | | just created, or a |
| | | | previously- |
| | | | existing |
| | | | accountid if the |
| | | | user already had |
| | | | an account and is |
| | | | logged in |
| Listing.mediaid | No | Null | |
| Listing.sortorder | No | Null/0 | |
| Listing.orgurl | No | Null | |
| Listing.registrationurl | No | Null | |
| Listing.altphone | No | Null | |
| Listing.faxphone | No | Null | |
| Listing.amountowed | No | 0 | |
| Listing.amountpaid | No | 0 | |
| Listing.minage | No | Null | |
| Listing.maxage | No | Null | |
| Listing.startdate | No | Current | |
| | | date/time | |
| Listing.expirationdate | No | Current | Since the listing |
| | | date/time | is not published |
| | | | this should not |
| | | | matter |
| Listing.answermap | No | NULL | Will not be used |
| | | | for program setup |
| Listing.description | No | Null | Not needed, |
| | | | listing will not |
| | | | actually be |
| | | | published |
| Listing.notes | No | Null | |
| Listing.insertedby | No | Web2website | |
| Listing.inserteddate | No | Current | |
| | | date/time | |
| Listing.modifiedby | No | Null | |
| Listing.modifieddate | No | Null | |
| Listing.publish | No | ALWAYS 0 | These listings are |
| | | | not published in |
| | | | the directory; |
| | | | they are “hidden” |
| | | | for online |
| | | | reporting only. |
| Listing.premium | No | 1 | |
| Listingprogram.listingprogramid | No | Listingprogram_seq.nextval | |
| Listingprogram.listingid | No | Listingid | This could be an |
| | | | existing listing id if |
| | | | the account already |
| | | | had one, or a new |
| | | | listing just created |
| | | | if the account didn't |
| | | | previously have |
| | | | one. |
| Listingprogram.Programid | No | Program.programid | This will be the |
| | | | program id of the |
| | | | newly created |
| | | | program. |
| Listingprogram.Sortorder | No | Null | |
| Listingprogram.Insertedby | No | Web2website | |
| Listingprogram.Inserteddate | No | Current | |
| | | date/time | |
| Listingprogram.Modifiedby | No | Null | |
| Listingprogram.Modifieddate | No | Null | |

Selected Program Relationships

| | Column | |
|---|---|---|
| Related Table | population | Description/notes |
| Fee | | |
| membership level fee | | |
| Content/additionalcontent | | program description |
| Forms | Static forms | May give event planners |
| | pre-created: | their choice of 3 or 4 |
| | Formid = xxxxxx | forms that they can |
| | (description) | utilize. May also allow |
| | Formid = xxxxxxx | them at some point to |
| | (description) | create their own flex- |
| | Formid = xxxxxxx | form questions. |
| | (description | |
| Program Form | | |
| Media (via content) | | (Images and documents |
| | | attached to the program). |
| Account | | |
| Listing | | |
| ListingProgram | | |

It should also be understood that, in addition to reunion planning, the systems and methods described herein can be used to create events of any kind. While preferred embodiments of the invention have been illustrated and described above, it will be appreciated that various changes can be made therein without departing from the scope of the invention. Changes in the system or method of use or operation, method of manufacture, shape, configuration, or components used that are not specified in the detailed written description above or illustrations contained herein, but which are considered apparent or obvious to one skilled in the art, are within the scope of the present invention. The scope of the invention is to be determined from the following claims and equivalents thereto.

1. A method for event planning and registration using a computer network, comprising:
executing one or more processes at a server computer that causes a display of an interface on a client device, wherein the interface prompts an event planner at the client device to enter information for planning an event and fees required from participants for the event;
creating one or more database records in the server computer for storing the event and fees information, such that the event and fees information is immediately available to event participants for event registration;
communicating the event and fees information to a client device for display to an event participant;
receiving a submission from the event participant to register for the event, wherein the submission includes fee payment instructions for the event registration; and
processing the event participant's registration and fee payment instructions and making the registration of the event participant immediately available to the event planner.

2. The method of claim 1, further comprising adding one or more images to the event and fees information, wherein the one or more images become available to event participants in real time when the event and fees information is available to event participants.

3. The method of claim 1, further comprising adding one or more documents to the event and fees information, wherein the one or more documents become available to event participants in real time when the event and fees information is available to event participants.

4. The method of claim 1, further comprising adding an event registration time constraint to the event and fees information, wherein the event registration time constraint becomes effective in real time when the event and fees information is available to event participants.

5. The method of claim 1, further comprising adding a maximum number of participants allowed to register for an event to the event and fees information, wherein the maximum number of participants becomes effective in real time when the event and fees information is available to event participants.

6. The method of claim 1, further comprising associating a vanity email address with the event and fees information for communication between an event participant and the event planner.

7. The method of claim 1, further comprising providing information on event registrations in real time to the event planner.

8. The method of claim 1, further comprising an adding age restriction to the event and fees information, wherein the age restriction becomes effective in real time when the event and fees information is available to event participants.

9. The method of claim 1, further comprising receiving a submission from the event planner to modify the event and fees information after the event and fees information has become available to event participants, and the modified event and fees information becomes effective in real time with the submission from the event planner.

10. The method of claim 1, further comprising enabling an event planner to create multiple different types of events that are made available to event participants without requiring outside intervention with the event planner.

11. A server operating in a client-server computing environment in which the server is configured to communicate with a plurality of clients via a computing network, the server comprising:
a processor; and
a memory coupled to the processor, wherein the memory is configured with computer-executable instructions that, when executed by the processor, result in:
providing an interface to a first client for display to an event planner, wherein the interface prompts the event planner to enter information for planning an event and fees required from participants for the event;
creating one or more database records in the server memory for storing the event and fees information, such that the event and fees information is immediately available to participants for event registration;
communicating the event and fees information to a second client for display to an event participant;
receiving a submission from the event participant to register for the event, wherein the submission includes fee payment instructions for the event registration; and
processing the event participant's registration and fee payment instructions such that the registration of the event participant is immediately available to the event planner.

12. The server of claim 11, further comprising computer-executable instructions that, when executed by the processor, result in adding one or more images to the event and fees information, wherein the one or more images become available in real time when the event and fees information is available to event participants.

13. The server of claim 11, further comprising computer-executable instructions that, when executed by the processor, result in adding one or more documents to the event and fees information, wherein the one or more documents become available in real time when the event and fees information is available to event participants.

14. The server of claim 11, further comprising computer-executable instructions that, when executed by the processor, result in adding event registration time constraints to the event and fees information, wherein the event registration time constraints become effective in real time when the event and fees information is available to event participants.

15. The server of claim 11, further comprising computer-executable instructions that, when executed by the processor, result in adding a maximum number of participants allowed to register for an event to the event and fees information, wherein the maximum number of participants becomes effective in real time when the event and fees information is available to event participants.

16. The server of claim 11, further comprising computer-executable instructions that, when executed by the processor, result in associating a vanity email address with the event and fees information for event participant communication with the event planner.

17. The server of claim 11, further comprising computer-executable instructions that, when executed by the processor, result in providing information on event registrations in real time to the event planner.

18. The server of claim 11, further comprising computer-executable instructions that, when executed by the processor, result in adding age restrictions to the event and fees information, wherein the age restrictions become effective in real time when the event and fees information is available to event participants.

19. The server of claim 11, further comprising computer-executable instructions that, when executed by the processor, enable the server to receive a submission from the event planner to modify the event and fees information after the event and fees information has become available to event participants, and the modified event and fees information becomes effective in real time with the submission from the event planner.

20. The server of claim 11, further comprising computer-executable instructions that, when executed by the processor, enable an event planner to create multiple different types of events that are made available to event participants without requiring outside intervention with the event planner.
